(19) United States
(12) Patent Application Publication
(10) Pub. No.: US 2007/0230546 A1
(43) Pub. Date: Oct. 4, 2007

(54) Equalizer with reduced complexity with application to long delay spread channels

(76) Inventors: Shimon Moshavi, Bet Shemesh (IL); Daniel Yellin, Raanana (IL)

Correspondence Address: Intellevate;900 Second Avenue South, Suite 1700, Minneapolis, MN, 55402, US

(21) Appl. No.: 11/393,435

(22) Filed: Mar. 30, 2006

(51) Int. Cl. H04B 1/00

(52) U.S. Cl. 375/150

(57) ABSTRACT

A signal processing apparatus to equalize a signal in a multipath channel, where the equalization is based upon forming a correlation vector and the inverse of a covariance matrix, where the covariance matrix is smaller in dimension than the correlation vector. In one embodiment, the signal processing apparatus forms an extended matrix from the inverse of the covariance matrix, equal in dimension to the correlation vector, by selecting one or more rows of the inverse covariance matrix and shifting the selected one or more rows to form the extended matrix. The extended matrix is multiplied by the correlation vector to provide filter weights to the equalizer. In some embodiments, filtering is performed by a sliding window correlator based upon the selected one or more rows of the covariance matrix, followed by filtering based upon the correlation vector.

### FIELD

Embodiments of the present invention relate to communication receivers, and more particularly, to equalizers for communication receivers used in multipath channels.

### BACKGROUND

Currently, most commercial CDMA (Code-Division-Multiple-Access) receivers are based on the so-called RAKE receiver. A RAKE receiver finds application to multi-path channels, and essentially implements a filter matched to the transmitted signal waveform and the multipath channel. The matched filter is known to be optimal for an AWGN (Additive White Gaussian Noise) channel. However, in the presence of significant interference from multipath inter-symbol-interference (ISI) and possibly other co-channel users, such as in cellular networks, the RAKE matched filter is no longer optimal and in some cases may be far from optimal.

In recent years, there has been significant research in developing advanced CDMA receiver algorithms to improve performance. For example, there is ongoing work in the 3GPP (3^{rd} Generation Partnership Project) standards body to implement new performance requirements for High Speed Downlink Packet Access (HSDPA) services based on the so-called LMMSE (Linear Minimum Mean Square Error) equalizer. The 3rd Generation Partnership Project is a collaboration agreement that was established in December 1998. The collaboration agreement brings together a number of telecommunications standards bodies. HSDPA is a new mobile telephony protocol, also called 3.5G (or 3½G), in the 3GPP standards. See www.3GPP.org.

In the case of the LMMSE equalizer, a linear transformation (or filter) is applied at the receiver so as to reduce the interference seen by the receiver. In particular, the linear transformation is chosen so as to minimize the mean square error (MSE) under a random spreading code assumption. The random spreading code assumption is that all user signature codes are unknown and random. Because of the random spreading code assumption, the derived linear transformation does not depend on the signature codes, but rather on more slowly changing parameters, such as the multipath channel, the base station transmit power, and the noise level.

In a sense, the LMMSE equalizer attempts to invert the multipath channel and remove its distorting effect. The LMMSE equalizer may be particularly powerful for typical CDMA systems because the downlink communication path generally utilizes orthogonal signature codes between users within the same cell. Therefore, removing the distorting effects of the channel with an equalizer-type receiver restores the orthogonality of user waveforms, and suppresses same-cell co-channel interference.

The LMMSE equalizer applies a linear transformation or filter to a sample window of received samples, or chips, in order to produce an output. However, computing the LMMSE linear transformation or filter solution exactly requires the inverse of a covariance matrix whose dimension is the size of the sample window. For long sample windows, the resulting computational requirement in performing such a matrix inverse may be too burdensome.

### BRIEF DESCRIPTION OF THE DRAWINGS

FIG. 1 illustrates the formation of an extended matrix according to an embodiment of the present invention.

FIG. 2 illustrates the formation of an extended matrix for a particular sample window size, according to an embodiment of the present invention.

FIG. 3 illustrates modules for an embodiment of the present invention.

FIG. 4 is a receiver at the system level according to an embodiment of the present invention.

### DESCRIPTION OF EMBODIMENTS

Before describing embodiments of the present invention, it is useful to first consider the LMMSE equalizer. The LMMSE equalizer is commonly applied to the received signal at the chip level or sample level. In this case, a linear transformation, or filter, denoted as a column vector w, is chosen to satisfy,

$$min E {\vert \frac{{\tilde{c}}_{{b}_{o} , {k}_{o} , d}}{E [ {\vert {\tilde{c}}_{{b}_{o} , {k}_{o} , d} \vert}^{2} ]} - {w}^{H} v \vert}^{2} \qquad ( 1 )$$

where \tilde{c}_{b}_{ₒ}_{,k}_{ₒ}_{,d} is the desired complex-valued chip symbol for desired user kₒ of base bₒ at delay d, and v is the column vector of received chips or samples. The normalization by the chip energy shown in the denominator in Eq. (1) is optional and does not affect performance.

The solution to the above MMSE (Minimum MSE) problem is well-known, and can be shown to be:
w^{H}=E[\tilde{c}_{b}_{ₒ}_{,k}_{ₒ}_{,d}v^{H}](E[vv^{H}])⁻¹=rᵥₛ^{H}Rᵥᵥ⁻¹, (2)
where the covariance matrix Rᵥᵥ is defined as
Rᵥᵥ=E└vv^{H}┘,
and the correlation vector rᵥₛ is defined as
rᵥₛ^{H}=E[\tilde{c}_{b}_{ₒ}_{,k}_{ₒ}_{,d}v^{H}],
where the H denotes complex conjugate transpose (the Hermitian). In theory, the operator E denotes an ensemble average. In practice, a sample-data average may be used to estimate the ensemble average, or other estimation techniques may be used. Consequently, in the described embodiments, it is to be understood that E represents an averaging operator, which may include, but is not necessarily limited to, a calculated ensemble averaging operator or a sample-data averaging operator.

It is also to be understood that the term “covariance matrix” may be used when in practice only an estimate of the covariance matrix may be available. The term covariance matrix is to be understood to also include an estimated covariance matrix. Furthermore, the random spreading code assumption is assumed here and thus, the averaging also takes place over all user signature codes (in addition to data and noise).

Using the above LMME linear transformation can yield recovered chips with reduced interference. To recover the desired symbol, de-spreading is performed, whereby the received chips (filtered output from the LMME linear transformation or filter) are correlated with the time-aligned desired user's signature code waveform.

The operations defined in Eq. 2 can be viewed as two parts. The application of Rᵥᵥ⁻¹ (to the received signal) can be shown to be whitening of the received signal followed by applying a filter matched to the whitening filter. The application of rᵥₛ^{H} can be shown to be the application of a filter matched to the multipath channel. In other words, one can write rᵥₛ as
rᵥₛ=h_{d}, (3)
where h_{d} is a vector containing the multipath channel of the dth chip. We note that setting Rᵥᵥ=I reduces the LMMSE equalizer to a RAKE receiver (chip-spaced in the current discussion).

A key design parameter of the LMMSE equalizer receiver is the size of the sample window, i.e., the length of the received vector v in Eq. (1). The sample window determines the dimensions of the matrix Rᵥᵥ and the vector rᵥₛ=h_{d}, as well as the length of the linear filter w. In applying the LMMSE, there is a tradeoff between performance and complexity: the larger the sample window, the better the performance may be in stationary environments, but the higher the complexity. In particular, the dimension of Rᵥᵥ affects the computational resources needed to form Rᵥᵥ and its inverse, Rᵥᵥ⁻¹.

The impact of the sample window size (i.e., filter length) on LMMSE equalizer performance is dependent on the length of the multipath channel (delay spread) and the length of the inverse channel. If the length of the multipath channel is long, then the Rᵥᵥ matrix may not adequately represent the full signal covariance matrix. Furthermore, the vector rᵥₛ=h_{d} may not represent the full multipath channel waveform. On the other hand, if the length of the inverse multipath channel is long, then the matrix Rᵥᵥ⁻¹ may not adequately represent the inverse signal covariance matrix.

Multipath channels with long delay spread pose a particularly acute problem when significant multipath energy falls outside of the LMMSE equalizer sample window. This may happen, for example, if the delay spread is greater than the filter length. In this case, the portion of the solution which applies the multipath channel matched filter, rᵥₛ=h_{d}, may not capture all of the multipath energy, and the receiver will often perform significantly worse than the standard RAKE receiver, which does apply a full multipath channel matched filter.

Embodiments of the present invention form the inverse of a covariance matrix based on a dimension which is smaller than the sample window length, and then effectively extend the smaller dimensioned inverse covariance matrix to an extended matrix having the dimension of the sample window. Application of the extended matrix to a received signal may be implemented by a sliding window correlator applied to the received signal, followed by an inner product of the result with rᵥₛ^{H}=h_{d}^{H}. It is expected that embodiments should find utility for those cases in which the channel delay spread is larger in length than the dimension used to compute the covariance matrix.

We first describe embodiments for the single antenna and single time-sample per chip case. Later, it is described how the embodiments are easily generalized to the case in which there is more than one antenna, or more than one time-sample per chip.

Let L denote the length (in received samples) of the sample window used to form the channel matched filter correlation vector rᵥₛ^{H}.

Let M denote the length of a sample window according to which is formed a M×M covariance matrix R(M), where M<L. Thus, R(M) is equal to or an approximation of the covariance matrix E└v(M)v^{H}(M)┘, where v(M) is a received sample vector of length M.

Let R⁻¹(M) denote the inverse of R(M). In practice, due to numerical round-off errors and other numerical approximations, the exact inverse of R(M) is not actually calculated, but for simplicity of discussion, we refer to R⁻¹(M) as the inverse of R(M) although in practice it may be only an approximation to the inverse.

Let h^{H}(M) denote a row in the matrix R⁻¹(M). In preferred embodiments, h^{H}(M) is the middle row of R⁻¹(M). If M is odd, then the middle row is at row position (M+1)/2. If M is even, the middle row may be taken at row position (M/2) or at row position (M/2)+1. Embodiments need not be limited to using these particular rows for forming the row vector h^{H}(M).

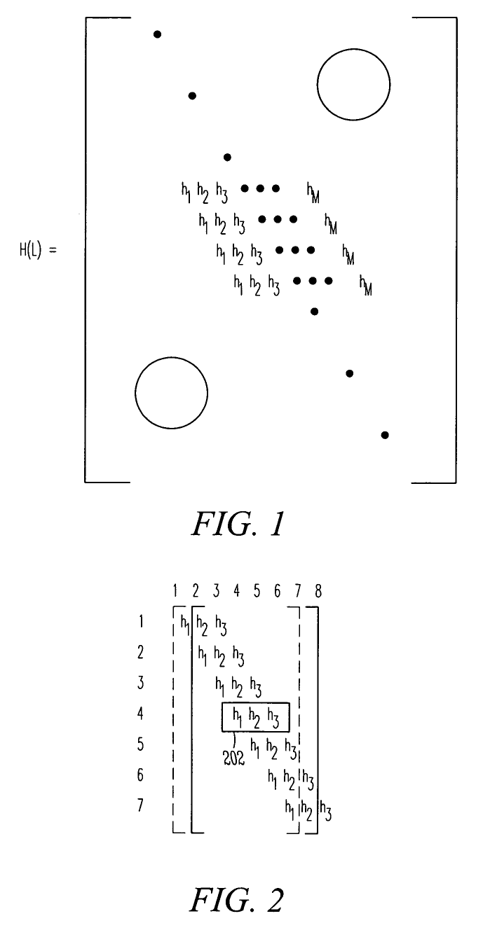

Let H(L) denote an L×L extended matrix formed from the row vector h^{H}(M). Roughly stated, the extended matrix H(L) is formed from the row vector h^{H}(M) by starting in the middle of a template L×L matrix and repeatedly shifting h^{H}(M) to the left and upward, and to the right and downward, so as to fill in the rows of the template to form the extended matrix H(L). The other elements of H(L) not formed by shifting h^{H}(M) are taken as zero. This may be visualized by FIG. 1, where the components of h^{H}(M) are written out as h^{H}(M)=[h₁ h₂ . . . h_{M}]. There will be edge effects as h^{H}(M) is shifted to the top and nearby top rows, and shifted to the bottom and nearby bottom rows, of the template matrix. These edge effects may be handled in various ways, and are easily discussed with respect to a specific example given below.

As a specific example, let M=3 and L=7, where h^{H}(M)=[h₁ h₂ h₃]. In FIG. 2, the elements of h^{H}(M) have been shifted a number of times. One may visualize the row inside box 202 as the row vector h^{H}(M), where the template has rows indexed from 1 through 7 and columns indexed from 2 through 8 as indicated in FIG. 2. The solid lines in FIG. 2 indicate the boundary of an extended matrix formed by shifting this row vector. For ease of discussion, we refer to this extended matrix as the solid extended matrix, and the template used as the solid template. We see that the first row in the solid extended matrix is [h₂ h₃], so that the first element of h^{H}(M) shifted outside of the solid template is simply dropped. Similarly, the last row in the solid extended matrix is [h₁ h₂], so that the last element of h^{H}(M) shifted outside the solid template as h^{H}(M) is also dropped.

As another example, again referring to FIG. 2, one may take the dashed lines as the boundary of another extended matrix, referred to as the dashed extended matrix. In this case, a new template, referred to as the dashed template, has rows indexed from 1 through 7, but with columns indexed from 1 through 7. The first row in the dashed extended matrix is [h₁ h₂ h₃], so that no element of h^{H}(M) is shifted outside of the dashed template as h^{H}(M) is shifted leftward and upward. The next to last row in the dashed extended matrix is [h₁ h₂], and the last row is [h₁], so that the elements of h^{H}(M) shifted outside the dashed template as h^{H}(M) are dropped.

Note that in forming the dashed extended matrix, box 202 is not exactly centered in the dashed template. That is, the first element of [h₁ h₂ h₃] is in the center of the dashed template. However, in forming the solid extended matrix, box 202 is exactly centered in the solid template. That is, the middle element of [h₁ h₂ h₃] is in the center of the solid template.

The extended matrix H(L) may be thought of as an approximation to the inverse of the covariance matrix Rᵥᵥ=E└vv^{H}┘. But, because the dimension of R(M) may be in practice much smaller than the dimension of Rᵥᵥ, (i.e., L), embodiments of the present invention are expected to have a lower computational burden than the LMMSE equalizer.

The filter applied to the received signal vector using the extended matrix may be written as
w^{H}=rᵥₛ^{H}H(L). (4)
Applying the above filter to a received signal vector may be performed in various ways. One way is to carry out the mathematical operations implicit in Eq. (4) by pre-multiplying H(L) by the vector rᵥₛ^{H} to obtain the filter vector w^{H}. The filtered output for a signal vector x is then given by w^{H}x. It is to be understood that the application of the filter vector w^{H} may be implemented in a number of ways including the use of a sliding window correlator, filter, or RAKE structure (e.g., where code de-spreading is done according to the timing of each of the taps as modeled in w^{H} and where the tap values are multiplied with the corresponding de-spread symbol outputs and summed).

In other embodiments, the received signal vector may first be pre-multiplied by H(L), but because of the structure of this matrix, this pre-multiplication is easy to perform, and involves a sliding window correlator or filter. For a signal vector x, elements of the pre-multiplication H(L)x may be written as h[x]ᵢ where [x]ᵢ denotes an M dimensional window of x starting at position i of x and ending at position i+M−1, and where the index i varies from 1 to L−M+1. However, the above formalism is not quite correct for those indices of i for which the previously described edge effects occur for the corresponding rows of H(L). In this case, modification of h[x]ᵢ should be straightforward for those particular indices, and depends upon the type of edge effects that occur. For example, one can simply continue to use the same filter or sliding window correlator for many samples until a new equalizer is computed. In this case, edge effects will occur at the transition between filters. Assuming such modifications have been made to correct for the edge effects, the elements h[x]ᵢ are then multiplied by the elements of rᵥₛ^{H} to provide the filtered output. It is to be understood that the application of the channel matched filter correlation vector rᵥₛ^{H} can be implemented in a number of ways including the use of a sliding window correlator, filter, or RAKE structure (e.g., where code de-spreading is done according to the timing of each of the channel taps as modeled in rᵥₛ^{H} and where the channel tap values are multiplied with the corresponding de-spread symbol outputs and summed).

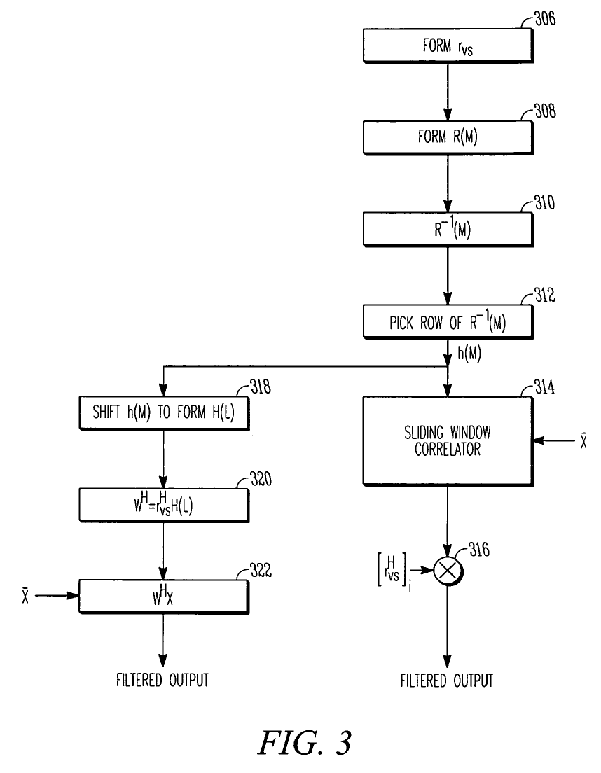

The flow diagram of FIG. 3 may serve as a description of either an apparatus or method according to one or more embodiments. Some or all of the modules in FIG. 3 may represent a hardwired circuit, a programmable processor running software, a software module, or other type of circuit utilizing micro-code or firmware.

Referring to FIG. 3, the vector rᵥₛ and covariance matrix R(M) are formed in modules 306 and 308, respectively. In module 310, the inverse of R(M) is performed, and in module 312, a row is chosen from this inverse. In module 314, the chosen row h^{H}(M) is used in a sliding window correlator or filter with a received signal vector x, and these resulting elements are multiplied with elements of rᵥₛ^{H}, indicated by multiplier 316, to provide the filtered output. Or, the row h^{H}(M) is shifted in module 318 to provide H(L), and in module 320 H(L) is pre-multiplied by the vector rᵥₛ^{H} to obtain the filter vector w^{H}, which is used to filter the signal vector x to provide the filtered output, as indicated in module 322.

The above description and formalism is easily generalized to the case in which there is more than one antenna, or more than one time-sample per chip, or both. For example, suppose there are n samples per chip resulting from some combination of multiple antennas and multiple time-samples per chip. In this case, the received signal vector v is of dimension nL and may be written as
v^{T}=[v^{T}(1)v^{T}(2) . . . v^{T}(L)] (5)
where v^{T}(i) denotes sample i and is a n dimensional row vector denoting the n samples for chip i, and T denotes transpose.

The vector rᵥₛ^{H} and matrix R(M) are formally formed as before, but now rᵥₛ^{H} is of dimension nL, R(M) is a nM×nM matrix, and n contiguous rows of R⁻¹(M) are chosen to form an nL×nL extended matrix. In addition, the block of n contiguous rows of R⁻¹(M) is shifted each time by n elements to the left or right in forming the extended matrix. We may formally represent the n contiguous rows of R⁻¹(M) used to form the extended matrix by the n×M matrix h^{H}(n,M), and we may formally represent the nL×nL extended matrix as H(n,L).

The matrices h^{H}(n,M) and H(n,L) now take the place, respectively, of h^{H}(M) and H(L), where multiplication or a sliding window correlator may be utilized to provide the filtered output. Again, edge effects should be addressed as for the single sample-per-chip cases.

We note that if H(n,L) is first applied to the received samples, before application of the channel matched filter correlation vector, then each of the n rows of h^{H}(n,M) is separately applied to the corresponding (one of n) chip-spaced received sample stream via a sliding window correlator or a filter to produce a n-sample-per-chip output; the n-sample-per-chip channel matched filter correlation vector then pre-multiplies this output to produce the equalizer filter output. It is to be understood that the application of the channel matched filter correlation vector can be implemented in a number of ways, including the use of sliding window correlators, filters, or a RAKE structure.

Alternatively, the n-sample-per-chip channel matched filter correlation vector may first be applied to H(n,L) to compute the filter vector w^{H}, which may in turn be applied to the received samples. It is to be understood that the application of the filter vector w^{H} may be implemented in a number of ways including the use of sliding window correlators, filters, or a RAKE structure.

It is also to be understood that embodiments may include alternate ways of ordering the samples within the received sample vector v. This would result in a corresponding change in the method of extending the matrix R⁻¹(M) to obtain H(n,L). For example, for each of the n chip-spaced received sample streams, one may group all L chip-spaced samples in v contiguously. This would result in a covariance matrix Rᵥᵥ with n separate blocks of dimension L, and with a similar approximate block structure for its inverse. In such a case, the procedure for extending R⁻¹(M) to the nL×nL extended matrix H(n,L) is performed by separately extending each of the n M×M blocks to L×L size as was done in the one sample-per-chip case.

It is expected that an advantage of the above-described embodiments over a conventional LMMSE approach is that an embodiment equalizer in a sense whitens the received signal given the restricted sample window length M, but the capturing of multipath energy is not so limited because a larger window length L is used for the channel matched filter correlation vector. This approach is expected to work particularly well when a significant portion of the multipath energy is clustered within a relatively small delay spread relative to the filter length, but for which there still may exist important multipath components outside the filter length interval. (The so-called Case 2 multipath case in 3GPP may serve as such an example.)

This approach makes use of information not available to MMSE processing in that it assumes that the channel statistics will not change significantly for the chips outside the sample window of length M, thus enabling the extended matrix to approximate Rᵥᵥ⁻¹ outside the sample interval used to form the matrix R(M). This may apply even for users at high speeds because the channel statistics may be relatively constant over a realistic delay spread interval.

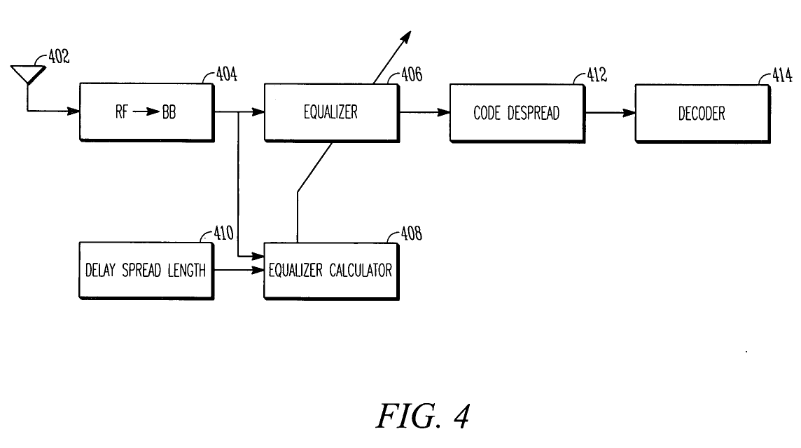

As the spread of the multipath energy increases, using an above-described embodiment equalizer at whitening may actually increase the loss of orthogonality due to the existing channel multipath. In this case, a relatively small loss in performance relative to the RAKE performance may occur. An alternate and simple method is to form the extended matrix to guarantee RAKE-like performance by simply substituting an extended identity matrix for the extended matrix when a long-delay spread condition occurs. This approach effectively switches between a RAKE receiver and the conventional LMMSE equalizer according to the delay spread conditions. An example of this modified equalizer receiver structure is shown in FIG. 4.

In FIG. 4, antenna 402 receives a radio frequency (RF) signal, which is down-converted to a baseband signal by module 404. Module 404 may be termed an analog front end, and may include such components as a RF amplifier, a mixer, and an analog-to-digital converter, to name just a few. The baseband signal is equalized by equalizer 406. Filter weights for equalizer 406 are computed by functional module 408, depending upon the delay spread length provided by module 410. For moderate delay spread length, the equalizer filter weights may be calculated as discussed earlier, whereas for relatively large delay spread length, in some embodiments the equalizer may utilize an identity matrix for the extended matrix as discussed previously. Code de-spread module 412 performs code de-spreading, and decoder 414 performs additional decoding, such as Viterbi or convolutional decoding.

The receiver illustrated in FIG. 4 may be included in a mobile communication device, such as a cell phone, laptop computer, or other mobile device, for example. The modules in FIG. 4 may be synthesized in one or more semiconductor dice, and may incorporate software or firmware, or a combination thereof. Embodiments of the present invention may find application to so-called chipsets in cell phones, but are not limited to such applications. Modifications may be made to the embodiment of FIG. 4. For example, the correlation vector may be applied after code de-spread module 412.

Various modifications may be made to the disclosed embodiments without departing from the scope of the invention as claimed below.

Various mathematical relationships are used to describe relationships among one or more quantities. For example, a mathematical relationship or mathematical transformation may express a relationship by which a quantity is derived from one or more other quantities by way of various mathematical operations, such as addition, subtraction, multiplication, division, etc. Or, a mathematical relationship may indicate that a quantity is larger, smaller, or equal to another quantity. These relationships and transformations are in practice not satisfied exactly, and should therefore be interpreted as designed for relationships and transformations. One of ordinary skill in the art may design various working embodiments to satisfy various mathematical relationships or transformations, but these relationships or transformations can only be met within the tolerances of the technology available to the practitioner.

Accordingly, in the following claims, it is to be understood that claimed mathematical relationships or transformations can in practice only be met within the tolerances or precision of the technology available to the practitioner, and that the scope of the claimed subject matter includes those embodiments that substantially satisfy the mathematical relationships or transformations so claimed.

What is claimed is:

1. An apparatus comprising:
a processing module to form a correlation vector based upon a first sample window length, to form a covariance matrix based upon a second sample window length, and to select at least one row of the inverse of the covariance matrix, where the first sample window length is greater than the second sample window length and the covariance matrix has a dimension less than a dimension of the correlation vector; and
a filter module to filter based upon the correlation vector, and based upon the selected at least one row of the inverse of the covariance matrix.

2. The apparatus as set forth in claim 1, the filter module comprising:
a sliding window correlator based on the selected at least one row of the inverse of the covariance matrix.

3. The apparatus as set forth in claim 1, wherein the processing module forms an extended matrix based upon shifts of the selected at least one row of the inverse of the covariance matrix, and multiplies the extended matrix by the correlation vector to provide a set of filter weights to the filter module.

4. The apparatus as set forth in claim 1, wherein the covariance matrix is a sample-data covariance matrix.

5. The apparatus as set forth in claim 1, further comprising:
a code de-spread module to de-spread a filtered signal, where the filtered signal is obtained by filtering a received signal based upon the selected at least one row of the inverse of the covariance matrix; and
a correlation module to apply the correlation vector to the de-spread signal provided by the code de-spread module.

6. A method comprising:
forming a correlation vector having a dimension equal to a first sample window length;
forming a covariance matrix based upon a second sample window length less than the first sample length, the covariance matrix having a dimension less than the dimension of the correlation vector;
forming an inverse of the covariance matrix;
selecting at least one row of the inverse of the covariance matrix; and
filtering a signal based upon the correlation vector, and based upon the selected at least one row of the inverse of the covariance matrix.

7. The method as set forth in claim 6, further comprising:
correlating at least a portion of the signal with the selected at least one row of the inverse of the covariance matrix.

8. The method as set forth in claim 6, further comprising:
forming an extended matrix based upon shifts of the selected at least one row of the inverse of the covariance matrix; and
multiplying the extended matrix by the correlation vector to provide a set of filter weights to filter the signal.

9. The method as set forth in claim 6, wherein the covariance matrix is a sample-data covariance matrix.

10. The method as set forth in claim 7, further comprising:
code de-spreading a filtered signal, where the filtered signal is obtained by filtering a received signal based upon the selected at least one row of the inverse of the covariance matrix; and
applying the correlation vector to the de-spread signal provided by the code de-spreading.

11. A mobile communication device comprising:
an antenna;
an analog front end;
a processing module to form a correlation vector based upon a first sample window length, to form a covariance matrix based a second sample window length, and to select at least one row of the inverse of the covariance matrix, where the first sample window length is larger than the second sample window length and the covariance matrix has a dimension less than a dimension of the correlation vector; and
a filter module to filter based upon the correlation vector, and based upon the selected at least one row of the inverse of the covariance matrix.

12. The mobile communication device as set forth in claim 11, the filter module comprising:
a sliding window correlator based on the selected at least one row of the inverse of the covariance matrix.

13. The mobile communication device as set forth in claim 11, wherein the processing module forms an extended matrix based upon shifts of the selected at least one row of the inverse of the covariance matrix, and multiplies the extended matrix by the correlation vector to provide a set of filter weights to the filter module.

14. The mobile communication device as set forth in claim 11, wherein the covariance matrix is a sample-data covariance matrix.

15. The mobile communication device as set forth in claim 11, further comprising:
a code de-spread module to de-spread a filtered signal, where the filtered signal is obtained by filtering a received signal based upon the selected at least one row of the inverse of the covariance matrix; and
a correlation module to apply the correlation vector to the de-spread signal provided by the code de-spread module.

16. An article of manufacture comprising content, the content when accessed causing a machine to:
form a correlation vector having a dimension equal to a first sample window length;
form a covariance matrix based upon a second sample window length less than the first sample length, the covariance matrix having a dimension less than the dimension of the correlation vector;
form an inverse of the covariance matrix;
select at least one row of the inverse of the covariance matrix; and
filter a signal based upon the correlation vector, and based upon the selected at least one row of the inverse of the covariance matrix.

17. The article of manufacture as set forth in claim 16, the content when accessed further causing the machine to:
correlate at least a portion of the signal with the selected at least one row of the inverse of the covariance matrix.

18. The article of manufacture as set forth in claim 16, the content when accessed further causing the machine to:
form an extended matrix based upon shifts of the selected at least one row of the inverse of the covariance matrix; and
multiply the extended matrix by the correlation vector to provide a set of filter weights to filter the signal.

19. The article of manufacture as set forth in claim 16, wherein the covariance matrix is a sample-data covariance matrix.

20. The article of manufacture as set forth in claim 17, the content when accessed further causing the machine to:
de-spread a filtered signal, where the filtered signal is obtained by filtering a received signal based upon the selected at least one row of the inverse of the covariance matrix; and
apply the correlation vector to the de-spread signal provided by the de-spreading.
